(19) United States
(12) Patent Application Publication
(10) Pub. No.: US 2019/0371274 A1
(43) Pub. Date: Dec. 5, 2019

(54) CONTROL DEVICE, HEAD-MOUNTED DISPLAY AND ROBOTIC SYSTEM

(71) Applicant: Seiko Epson Corporation, Tokyo (JP)

(72) Inventor: Yoshihito YAMADA, Chino (JP)

(21) Appl. No.: 16/423,365

(22) Filed: May 28, 2019

(30) Foreign Application Priority Data
May 29, 2018 (JP) 2018-102110

(51) Int. Cl. G09G 5/26; G09G 5/32; G09G 5/02; G02B 27/01; B25J 9/16

(52) U.S. Cl. CPC G09G 5/26; G09G 5/32; G09G 5/02; G02B 2027/0141; B25J 9/1674; G09G 2354/00; G02B 27/0172

(57) ABSTRACT

A control device configured to control a robot includes a display control section configured to change a display configuration other than a display position of operating information of the robot to be displayed on a display section configured to transmit visible light based on a distance between an operator and the robot, the display configuration in a case in which the distance between the operator and the robot is a first distance and the display configuration in a case in which the distance between the operator and the robot is a second distance shorter than the first distance are different from each other.

The present application is based on, and claims priority from JP Application Serial Number 2018-102110, filed May 29, 2018, the disclosure of which is hereby incorporated by reference herein in its entirety.

### BACKGROUND

### 1. Technical Field

The present disclosure relates to a control device, a head-mounted display and a robotic system.

### 2. Related Art

There have been conducted research and development of a technology for displaying operating information of a robot. Here, the operating information includes information representing an operation of the robot, information related to a production capacity of a production line in which the robot is operating. The information representing the operation of the robot includes information such as information representing the current state of the robot, information representing a position and a posture of a control point (e.g., a tool center point (TCP)) of the robot, information representing the moving speed of the control point and information representing a load (e.g., torque) applied to the robot. The information related to the production capacity includes information such as information representing the number of times the robot has performed an operation and information representing average time for which the robot has performed operations.

In this regard, there is known an information display system constituted by a head-mounted display constituted to be capable of projecting an image on a transmissive display section to be worn by an operator on the head, a position direction information acquisition section for obtaining information of a position of the operator and an eye direction of the operator, a calculation section for calculating a display configuration of the production equipment entering the eyesight of the operator via the display section from a position of the production equipment and a three dimensional configuration information and the information of the position and the eye direction of the operator, an operating information acquisition section for obtaining the operating information of the production equipment, and a display control section which sets a part corresponding to the production equipment entering the eyesight of the operator to a display inhibition area in the display section and displays the operating information in an area other than the display inhibition area when the information of the display configuration and the operating information are obtained (see JP-A-2017-102242 (Document 1)).

Here, the position of the production equipment in the eyesight of the operator varies in accordance with the change in the position and the eye direction of the operator. Therefore, in the information display system described in Document 1, the display position of the operating information in the eyesight of the operator also varies in accordance with the change in the position and the eye direction of the operator. As a result, in the information display system, it is difficult for the user to visually recognize the operating information in some cases.

### SUMMARY

An aspect of the present disclosure is directed to a control device configured to control a robot including a display control section configured to change a display configuration other than a display position of operating information of the robot to be displayed on a display section configured to transmit visible light based on a distance between an operator and the robot, wherein the display configuration in a case in which the distance between the operator and the robot is a first distance and the display configuration in a case in which the distance between the operator and the robot is a second distance shorter than the first distance are different from each other, and a display area of the operating information to be displayed on the display section in the case in which the distance between the operator and the robot is the second distance is smaller than a display area of the operating information to be displayed on the display section in the case in which the distance between the operator and the robot is the first distance.

Another aspect of the present disclosure is directed to a head-mounted display including a display section on which operating information of a robot is displayed, and which transmits visible light, and a display control section configured to change a display configuration other than a display position of the operating information to be displayed on the display section based on a distance between an operator and the robot, wherein the display configuration in a case in which the distance between the operator and the robot is a first distance and the display configuration in a case in which the distance between the operator and the robot is a second distance shorter than the first distance are different from each other, and a display area of the operating information to be displayed on the display section in the case in which the distance between the operator and the robot is the second distance is smaller than a display area of the operating information to be displayed on the display section in the case in which the distance between the operator and the robot is the first distance.

Another aspect of the present disclosure is directed to a robotic system including a robot, a head-mounted display having a display section on which operating information of the robot is displayed, and which transmits visible light, and a display control section configured to change a display configuration other than a display position of the operating information to be displayed on the display section based on a distance between an operator and the robot, wherein the display configuration in a case in which the distance between the operator and the robot is a first distance and the display configuration in a case in which the distance between the operator and the robot is a second distance shorter than the first distance are different from each other, and a display area of the operating information to be displayed on the display section in the case in which the distance between the operator and the robot is the second distance is smaller than a display area of the operating information to be displayed on the display section in the case in which the distance between the operator and the robot is the first distance.

### BRIEF DESCRIPTION OF THE DRAWINGS

FIG. 1 is a diagram showing an example of a configuration of a robotic system 1 according to an embodiment.

FIG. 2 is a diagram showing an example of a hardware configuration of a robot control device.

FIG. 3 is a diagram showing an example of a functional configuration of the robot control device.

FIG. 4 is a diagram showing an example of a flow of a process of the robot control device for making a display device display an operating information image.

FIG. 5 is a diagram showing an example of a scenery viewed by an operator through a display section provided to the display device in the case in which the operating information image with a first display configuration is displayed on the display device.

FIG. 6 is a diagram showing a first example of a scenery viewed by the operator through the display section provided to the display device in the case in which the operating information image with a second display configuration is displayed on the display device.

FIG. 7 is a diagram showing a second example of the scenery viewed by the operator through the display section provided to the display device in the case in which the operating information image with the second display configuration is displayed on the display device.

FIG. 8 is a diagram showing a third example of the scenery viewed by the operator through the display section provided to the display device in the case in which the operating information image with the second display configuration is displayed on the display device.

FIG. 9 is a diagram showing a fourth example of the scenery viewed by the operator through the display section provided to the display device in the case in which the operating information image with the second display configuration is displayed on the display device.

FIG. 10 is a diagram showing a fifth example of the scenery viewed by the operator through the display section provided to the display device in the case in which the operating information image with the second display configuration is displayed on the display device.

FIG. 11 is a diagram showing another example of the flow of the process of the robot control device for making the display device display the operating information image.

### DESCRIPTION OF AN EXEMPLARY EMBODIMENT

### Embodiment

An embodiment of the present disclosure will hereinafter be described with reference to the accompanying drawings.

### Configuration of Robotic System

Firstly, a configuration of a robotic system 1 will be described.

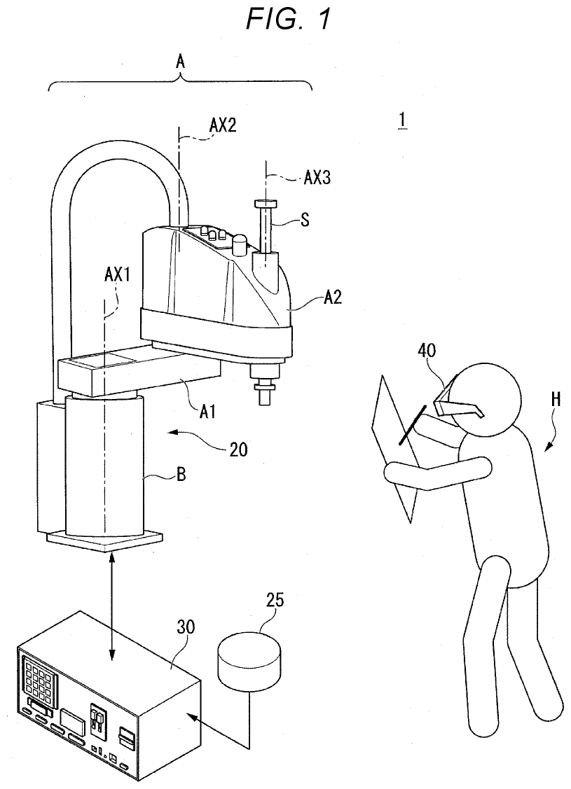

FIG. 1 is a diagram showing an example of the configuration of the robotic system 1 according to the embodiment. The robotic system 1 is provided with a robot 20 a position detection device 25, a robot control device 30 and a display device 40.

The robot 20 is a horizontal articulated robot (a scalar robot).

In the example shown in FIG. 1, the robot 20 is installed on a floor surface. It should be noted that it is also possible for the robot 20 to have a configuration of being installed on another surface such as a wall surface, a ceiling surface, an upper surface of a table, a surface provided to a jig, or a surface provided to a board instead of the floor surface. In the following description, for the sake of convenience of explanation, a direction perpendicular to the surface on which the robot 20 is installed, and pointing the surface from the robot 20 is referred to as a lower side or a downward direction, and a direction opposite to the direction is referred to as an upper side or an upward direction. Hereinafter, as an example, there will be described the case in which the downward direction coincides with the direction of gravitational force, and at the same time coincides with a negative direction of a Z axis in a robot coordinate system RC as a robot coordinate system of the robot 20. It should be noted that it is also possible to adopt a configuration in which the downward direction does not coincide with either one or both of the direction of gravitational force and the negative direction.

The robot 20 is provided with a movable section A and a base B for supporting the movable section A.

The movable section A is provided with a first arm A1 supported by the base B so as to be pivotal around a first pivotal axis AX1, a second arm A2 supported by the first arm A1 so as to be pivotal around a second pivotal axis AX2, and a shaft S supported by the second arm A2 so as to be pivotal around a third pivotal axis AX3, and translatable in an axial direction of the third pivotal axis AX3.

The shaft S is a shaft body having a columnar shape. On the circumferential surface of the shaft S, there are formed a ball screw groove and a spline groove not shown. The shaft S is disposed so as to penetrate an end part on an opposite side to the first arm A1 in the end part of the second arm A2 in a vertical direction in this example.

To an end part on the lower side out of the end parts provided to the shaft S, it is possible to attach an external device such as an end effector. Nothing is attached to the end part shown in FIG. 1. The end effector to be attached to the end part can also be an end effector capable of holding an object with finger parts, or can also be an end effector capable of holding an object due to adsorption or the like with air or magnetism, or can also be another end effector capable of holding an object. Further, the end effector attached to the end part can also be an end effector which cannot hold an object. It should be noted that in the present embodiment, holding an object means to make the object come into the state in which the object can be taken up.

In this example, the first arm A1 pivots around the first pivotal axis AX1, and moves in the horizontal direction. The horizontal direction is a direction perpendicular to the vertical direction. In other words, in this example, the horizontal direction is a direction along an X-Y plane which is a plane stretched by the X axis and the Y axis in the robot coordinate system RC. It should be noted that the horizontal direction can be a direction not perpendicular to the vertical direction instead of the direction perpendicular to the vertical direction. Further, the horizontal direction can also be a direction not parallel to the X-Y plane instead of the direction parallel to the X-Y plane.

Further, the first arm A1 is pivoted (driven) around the first pivotal axis AX1 by a first motor not shown provided to the base B. The first motor pivots the first arm A1 around the first pivotal axis AX1. In other words, in this example, the first pivotal axis AX1 denotes an imaginary axis coinciding with the pivotal axis of the first motor. It should be noted that the first pivotal axis AX1 can also be an imaginary axis not coinciding with the pivotal axis of the first motor.

In this example, the second arm A2 pivots around the second pivotal axis AX2, and moves in the horizontal direction. The second arm A2 is pivoted around the second pivotal axis AX2 by a second motor not shown provided to the second arm A2. The second motor pivots the second arm A2 around the second pivotal axis AX2. In other words, in this example, the second pivotal axis AX2 denotes an imaginary axis coinciding with the pivotal axis of the second motor. It should be noted that the second pivotal axis AX2 can also be an imaginary axis not coinciding with the pivotal axis of the second motor.

Further, the second arm A2 is provided with a third motor not shown and a fourth motor not shown, and supports the shaft S. The third motor pivots a ball screw nut provided to a circumferential part of the ball screw groove of the shaft S with a timing belt or the like to thereby move (move up and down) the shaft S in the vertical direction. The fourth motor pivots a ball spline nut provided to a circumferential part of the spline groove of the shaft S with a timing belt or the like to thereby pivot the shaft S around the third pivotal axis AX3. In other words, the third pivotal axis AX3 denotes an imaginary axis coinciding with the central axis of the shaft S. It should be noted that it is also possible for the third pivotal axis AX3 to be an imaginary axis not coinciding with the central axis of the shaft S.

The robot 20 is coupled to the robot control device 30 so as to be able to communicate with each other wirelessly or with wire.

The position detection device 25 detects the position of the operator H in the periphery of the robot 20. Here, the operator H denotes a person who performs a certain operation in the periphery of the robot 20. In the example shown in FIG. 1, the operator H wears the display device 40 described later, and performs an operation in the periphery of the robot 20. The periphery of the robot 20 denotes the inside of a chamber where the robot 20 is installed, but is not limited thereto, and can denote the inside of a spherical area with a predetermined radius centering on the robot 20, or can also denote the inside of an area where the robot 20 can perform an operation, or can also denote the inside of another area corresponding to the robot 20.

The position detection device 25 is, for example, an area sensor. The position detection device 25 detects the position of the operator H in the periphery of the robot 20 to output operator position information representing the position thus detected to the robot control device 30.

The position detection device 25 is coupled to the robot control device 30 so as to be able to communicate with each other wirelessly or with wire.

The robot control device 30 makes the robot 20 perform a predetermined operation with the control based on an operation program stored in advance.

Further, the robot control device 30 generates an operating information image including operating information of the robot 20, and then makes the display device 40 display the operating information image thus generated. In other words, the robot control device 30 makes the display device 40 display the operating information of the robot 20. Here, the operating information includes first information and second information different from the first information. The first information includes information representing the current state of the robot 20. The current state of the robot 20 denotes, for example, a state in which the robot 20 is at rest, a state in which the robot 20 is performing a continuous operation, and a state in which the robot 20 is performing a teaching operation. Further, the second information includes apart or the whole of the information representing an operation of the robot 20, the information related to the production capacity of the production line in which the robot 20 is operating, and so on. Further, the information representing an operation of the robot 20 includes a part or the whole of information representing a position of a control point (e.g., a tool center point (TCP), or an imaginary point associated with the tip of the robot 20) and the attitude of the robot 20, information representing the moving speed of the control point, information representing a load (e.g., torque) currently applied to robot 20, information (e.g., attention-seeking information described later) representing some warning related to the robot 20, and so on. Further, the information related to the production capacity includes a part or the whole of the information representing the number of times the robot 20 has performed an operation, information representing average time for which the robot has performed operations, and so on.

Further, the robot control device 30 obtains operator position information from the position detection device 25. The robot control device 30 calculates the distance between the operator H and the robot 20 based on the operator position information thus obtained. The robot control device 30 changes the display configuration other than the display position of the operating information image displayed on the display device 40 based on the distance thus calculated. Thus, it is possible for the robot control device 30 to make the display device 40 display the operating information with an appropriate display configuration in accordance with the distance between the operator H and the robot 20. In the present embodiment, each of the process of the robot control device 30 for making the display device 40 display the operating information image, and the display configuration thereof will be described in detail. Here, in this example, the display configuration other than the display position of the operating information image is represented by a size, a color, a transmittance, a shape and so on of the operating information image. It should be noted that the operating information image is an example of the operating information. Further, the display configuration other than the display position of the operating information image is an example of a display configuration other than a display position of the operating information. Further, the robot control device 30 is an example of a control device.

The display device 40 is, for example, ahead-mounted display. Specifically, the display device 40 has a display section (e.g., a display) for transmitting visible light, and is capable of displaying an image in a part or the whole of the display section. As described above, in the example shown in FIG. 1, the display device 40 is worn by the operator H in accordance with a predetermined wearing method. In the case in which the operator H wears the display device 40 in accordance with the wearing method, the display section provided to the display device 40 is disposed so as to mask at least a part of the eyesight of the operator H. However, since the display section transmits the visible light, the operator H can see an object through the display section. Therefore, it is possible for the display device 40 to display an image in at least a part of the eyesight of the operator. Here, the display device 40 obtains a variety of images from the robot control device 30. The display device 40 makes the display section provided to the display device 40 display the images thus obtained. For example, the display device 40 obtains the operating information image from the robot control device 30, and then makes the display section display the operating information image thus obtained.

The display device 40 is coupled to the robot control device 30 so as to be able to communicate with each other wirelessly or with wire.

It should be noted that the display device 40 can be a teaching pendant instead of the head-mounted display, or can also be a laptop personal computer (PC), a tablet PC, a multifunctional mobile phone unit (a smartphone), a mobile phone unit, a personal digital assistant (PDA) or the like, or another display device capable of displaying the image obtained from the robot control device 30. In such cases, the display device 40 is not worn by the operator H, but is carried by the operator H during the operation of the operator H.

### Hardware Configuration of Robot Control Device

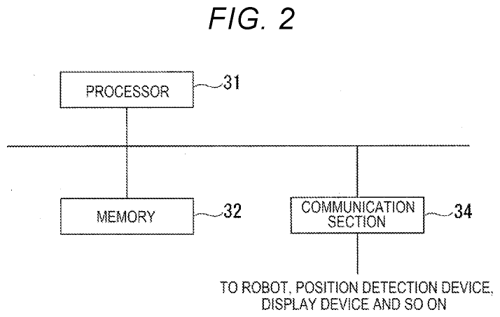

The hardware configuration of the robot control device 30 will hereinafter be described with reference to FIG. 2. FIG. 2 is a diagram showing an example of the hardware configuration of the robot control device 30. The robot control device 30 is provided with, for example, a processor 31, a memory 32 and a communication section 34. These constituents are connected via a bus so as to be able to communicate with each other. Further, the robot control device 30 communicates with each of the robot 20, the position detection device 25 and the display device 40 via the communication section 34.

The processor 31 is, for example, a central processing unit (CPU). It should be noted that the processor 31 can also be another type of processor such as a field programmable gate array (FPGA). The processor 31 executes a variety of programs stored in the memory 32.

The memory 32 includes, for example, a hard disk drive (HDD), a solid state drive (SSD), an electrically erasable programmable read-only memory (EEPROM), a read-only memory (ROM), and a random access memory (RAM). It should be noted that the memory 32 can also be an external storage device coupled using a digital input/output port such as the universal serial bus (USB) instead of one built into the robot control device 30. The memory 32 stores a variety of types of information, a variety of images, operation programs, and so on to be processed by the robot control device 30.

The communication section 34 is configured by including, for example, a digital input/output port such as the USB, or an Ethernet (registered trademark) port.

It should be noted that it is also possible for the robot control device 30 to have a configuration provided with an input device such as a keyboard, a mouse or a touch pad. Further, it is also possible for the robot control device 30 to have a configuration including a display device provided with a liquid crystal display panel, an organic electroluminescence (EL) display panel or the like.

### Functional Configuration of Robot Control Device

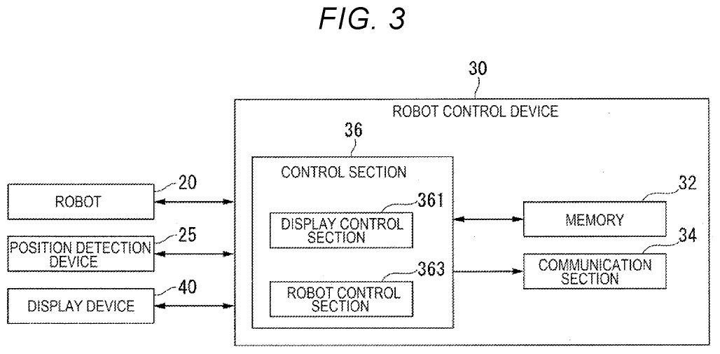

The functional configuration of the robot control device 30 will hereinafter be described with reference to FIG. 3. FIG. 3 is a diagram showing an example of the functional configuration of the robot control device 30. The robot control device 30 is provided with the memory 32, the communication section 34, and a control section 36.

The control section 36 controls the whole of the robot control device 30. The control section 36 is provided with a display control section 361 and a robot control section 363. These functional sections provided to the control section 36 are realized by, for example, the processor 31 executing a variety of programs stored in the memory 32. Further, some or all of these functional sections can also be hardware functional sections such as a large scale integration (LSI), or an application specific integrated circuit (ASIC).

The display control section 361 generates a variety of images, which the display device 40 is made to display. The display control section 361 outputs the image thus generated to the display device 40 to make the display device 40 display the image.

The robot control section 363 controls the robot 20 to make the robot 20 perform a predetermined operation.

### Process of Robot Control Device for Making Display Device Display Operating Information Image

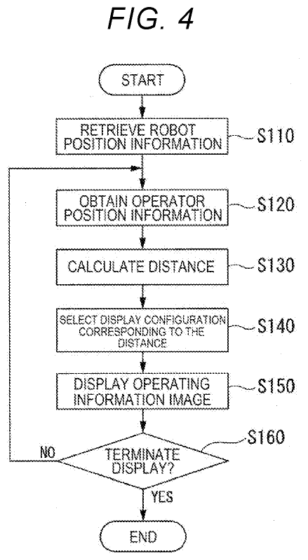

The process of the robot control device 30 for making the display device 40 display the operating information image will hereinafter be described with reference to FIG. 4. FIG. 4 is a diagram showing an example of a flow of a process of the robot control device 30 for making the display device 40 display the operating information image. It should be noted that there is hereinafter described, as an example, the case in which the robot control device 30 has received an operation of making the display device 40 display the operating information image from the operator H at the timing prior to execution of the process of the step S110 shown in FIG. 4.

The display control section 361 retrieves (step S110) robot position information stored in advance in the memory 32 from the memory 32. The robot position information denotes information representing the position of the robot 20 in the periphery of the robot 20. The position of the robot 20 is represented by, for example, a position determined in advance in the base B. Further, it is possible to adopt a configuration in which the position of the robot 20 is represented by a coordinate system representing the position in the chamber where the robot 20 is installed, or a configuration in which the position of the robot 20 is represented by a world coordinate system (e.g., a configuration in which the position of the robot 20 is represented by latitude and longitude), or a configuration in which the position of the robot 20 is represented by the robot coordinate system RC, or a configuration in which the position of the robot 20 is represented by another coordinate system. It should be noted that the position represented by the robot position information is represented by the same coordinate system as the coordinate system representing the position of the operator H described above. Hereinafter, the case in which each of the position of the robot 20 in the periphery of the robot 20 and the position of the operator H in the periphery of the robot 20 is represented by the robot coordinate system RC will be described as an example.

Then, the display control section 361 obtains (step S120) the operator position information from the position detection device 25. It should be noted that the process in the step S110 can also be performed in parallel to the process in the step S120 so as to be performed every time together with the process in the step S120.

Then, the display control section 361 calculates (step S130) the distance between the operator H and the robot based on the position represented by the position information retrieved in the step S110 and the position represented by the operator position information retrieved in the step S120.

Then, the display control section 361 selects (step S140) the display configuration corresponding to the distance calculated in the step S130. The display configuration denotes the display configuration of the operating information image. Hereinafter, the case in which the display configurations which the display control section 361 can select are only two, namely a first display configuration and a second display configuration, will be described as an example. In the case in which the display configurations the display control section 361 can select are only two, namely the first display configuration and the second display configuration, the display control section 361 determines that the distance calculated in the step S130 is a first distance in the case in which the distance calculated in the step S130 is a distance no smaller than a first threshold value determined in advance. Then, the display control section 361 selects the first display configuration as the display configuration corresponding to the first distance. In contrast, in the case in which the display configurations the display control section 361 can select are only two, namely the first display configuration and the second display configuration, the display control section 361 determines that the distance calculated in the step S130 is a second distance in the case in which the distance calculated in the step S130 is a distance smaller than the first threshold value. Then, the display control section 361 selects the second display configuration as the display configuration corresponding to the second distance. It should be noted that the number of the display configurations which the display control section 361 can select can also be equal to or larger than three.

Then, the display control section 361 generates the operating information image with the display configuration selected in the step S140. Then, the control section 361 outputs the operating information image thus generated to the display device 40 to make (step S150) the display device 40 display the operating information image.

Then, the display control section 361 determines (step S160) whether to terminate the display of the operating information image on the display device 40. For example, in the case in which the display control section 361 has received the operation of terminating the display from the operator H, the display control section 361 determines to terminate the display. In contrast, in the case in which the display control section 361 has not received the operation from the operator H, the display control section 361 determines not to terminate the display.

In the case in which it has been determined that the display of the operating information image on the display device 40 is not terminated (NO in the step S160), the display control section 361 makes the transition to the step S120 to obtain the operator position information once again from the position detection device 25. In contrast, in the case in which it has been determined that the display is terminated (YES in the step S160), the display control section 361 terminates the process.

### Specific Example of Operating Information Image with First Display Configuration and Operating Information Image with Second Display Configuration

Hereinafter, a specific example of the operating information image with the first display configuration and the operating information image with the second display configuration will be described. Here, the case in which the size of the background in the operating information image is determined in accordance with the size of the characters in the operating information image will hereinafter be described as an example. Further, the case in which the color of a frame of the background in the operating information image becomes the same color as the color of the characters in the operating information image will hereinafter be described as an example. Further, the case in which the shape of the operating information image does not change from a predetermined shape will hereinafter be described as an example. It should be noted that it is also possible to adopt a configuration in which the size of the background in the operating information image is determined independently of the size of the characters in the operating information image. Further, it is also possible to adopt a configuration in which the color of the frame of the background in the operating information image is determined independently of the color of the characters in the operating information image. Further, it is also possible to adopt a configuration in which the shape of the operating information image changes in accordance with the display configuration selected.

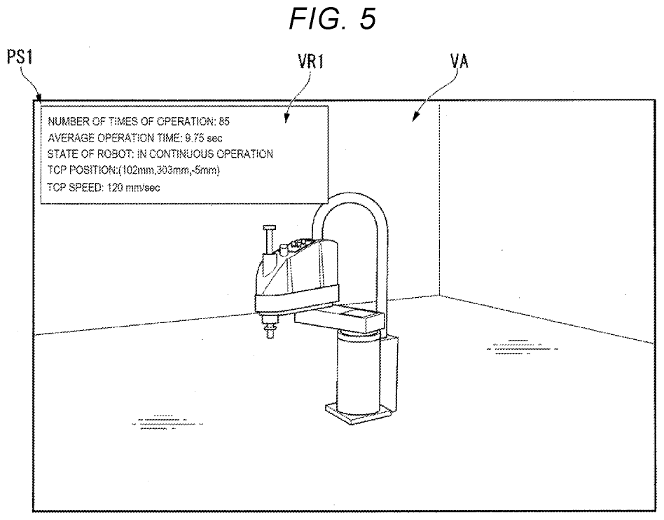

In the case in which the distance between the operator H and the robot 20 is the first distance, the display control section 361 makes the display device 40 display, for example, a first image VR1 shown in FIG. 5 as the operating information image with the first display configuration. FIG. 5 is a diagram showing an example of a scenery viewed by the operator H through the display section provided to the display device 40 in the case in which the operating information image with the first display configuration is displayed on the display device 40. Here, an area VA shown in FIG. 5 represents an example of the eyesight of the operator H. Further, the first image VR1 shown in FIG. 5 represents an example of the operating information image with the first display configuration.

The first image VR1 is displayed at a display position PS1 determined in advance in the display area of the display device 40. Here, the display position of the first image VR1 in the display area is represented by a position of the uppermost left end of the first image VR1 in this example. In other words, in the case in which the first image VR1 is displayed in the display area, the position of the uppermost left end of the first image VR1 coincides with the display position PS1. It should be noted that it is also possible to adopt a configuration in which the display position of the first image VR1 in the display area is represented by another position corresponding to the first image VR1.

Further, the first image VR1 includes the character string “STATE OF ROBOT: IN CONTINUOUS OPERATION” as the first information representing the current state of the robot 20. Further, the first image VR1 includes four types of information as the second information. Specifically, the first image VR1 includes the four types of information (the four types of character strings), namely “NUMBER OF TIMES OF OPERATION: 85,” “AVERAGE OPERATION TIME: 9.75 sec,” “TCP POSITION: (102 mm, 303 mm, −5 mm),” and “TCP SPEED: 120 mm/sec,” as the second information.

Here, in the case in which the distance between the operator H and the robot 20 is the first distance, the display control section 361 obtains the information representing the current state of the robot 20 from the robot control section 363 in, for example, the step S150 described above. Further, in that case, the display control section 361 obtains the information representing the number of times the predetermined operation is performed from the robot control section 363 in the step S150. Further, in that case, the display control section 361 obtains the information representing the average time for which the robot 20 performs the operation from the robot control section 363 in the step S150. Further, in that case, the display control section 361 obtains the information representing respective pivotal angles of four motors provided to the robot 20 from respective encoders of the four motors, and then calculates the position of the TCP based on the information thus obtained in the step S150. Further, in that case, the display control section 361 obtains the information representing the speed of the TCP from the robot control section 363 in the step S150. Then, the display control section 361 generates, for example, the first image VR1 as the operating information image with the first display configuration based on the information thus obtained and the position thus calculated.

Further, in the first image VR1, a standard character color as a predetermined color of the characters is used as the color of the characters in the first image VR1. Further, in the first image VR1, a standard character size as a predetermined size of the characters is used as the size of the characters in the first image VR1. Further, in the first image VR1, a standard character transmittance as a predetermined transmittance of the characters is used as the transmittance of the characters in the first image VR1. Further, in the first image VR1, a standard background color as a predetermined color of the background is used as the color of the background in the first image VR1. Further, in the first image VR1, a standard background transmittance as a predetermined transmittance of the background is used as the transmittance of the background in the first image VR1.

It should be noted that it is also possible to adopt a configuration in which the first image VR1 includes other information such as other character strings or other images. Further, although the shape of the first image VR1 shown in FIG. 5 is a rectangular shape, another shape can also be adopted instead of the rectangular shape.

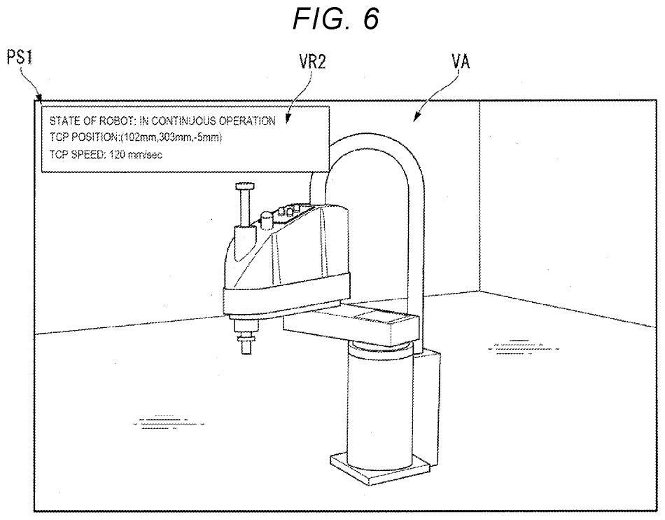

In contrast, in the case in which the distance between the operator H and the robot 20 is the second distance, the display control section 361 makes the display device 40 display, for example, a second image VR2 shown in FIG. 6 as the operating information image with the second display configuration. FIG. 6 is a diagram showing a first example of the scenery viewed by the operator H through the display section provided to the display device 40 in the case in which the operating information image with the second display configuration is displayed on the display device 40. Here, the second image VR2 shown in FIG. 6 represents an example of the operating information image with the second display configuration.

As described above, the display control device 361 changes the display configuration other than the display position of the operating information image of the robot 20 displayed on the display device 40 based on the distance between the operator H and the robot 20. Therefore, in the example shown in FIG. 6, the second image VR2 is displayed at the display position PS1 described above in the display area of the display device 40. Here, the display position of the second image VR2 in the display area is represented by a position of the uppermost left end of the second image VR2 in this example similarly to the case of the first image VR1. In other words, in the case in which the second image VR2 is displayed in the display area, the position of the uppermost left end of the second image VR2 coincides with the display position PS1. Thus, it is possible for the display control section 361 to prevent the visibility of the operating information image for the operator H from deteriorating due to the change in the position of the operating information image.

The second image VR2 is an image smaller in the number of pieces of the second information included therein than the first image VR1. Specifically, in the examples shown in FIG. 5 and FIG. 6, the number of pieces of the second information to be displayed on the display device 40 in the case in which the distance between the operator H and the robot 20 is the second distance shorter than the first distance is smaller than the number of pieces of the second information to be displayed on the display device 40 in the case in which the distance between the operator H and the robot 20 is the first distance.

Specifically, the second image VR2 includes two types of information as the second information. Specifically, the second image VR2 includes the two types of information (the two types of character strings), namely “TCP POSITION: (102 mm, 303 mm, −5 mm)” and “TCP SPEED: 120 mm/sec,” as the second information. Further, the second image VR2 includes the character string “STATE OF ROBOT: IN CONTINUOUS OPERATION” as the first information representing the current state of the robot 20. As described above, in the examples shown in FIG. 5 and FIG. 6, the number of pieces of the second information to be displayed on the display device 40 in the case in which the distance between the operator H and the robot 20 is the second distance shorter than the first distance is smaller than the number of pieces of the second information to be displayed on the display device 40 in the case in which the distance between the operator H and the robot 20 is the first distance.

Here, in the case in which the distance between the operator H and the robot 20 is the second distance, the display control section 361 obtains, for example, the information representing the current state of the robot 20 from the robot control section 363 in the step S150 described above. Further, in that case, the display control section 361 obtains the information representing the respective pivotal angles of the four motors provided to the robot 20 from, for example, the respective encoders of the four motors, and then calculates the position of the TCP based on the information thus obtained in the step S150. Further, in that case, the display control section 361 obtains, for example, the information representing the speed of the TCP from the robot control section 363 in the step S150. Then, the display control section 361 generates, for example, the second mage VR2 as the operating information image based on the information thus obtained and the position thus calculated.

Further, in the second image VR2 shown in FIG. 6, the color of the characters, the size of the characters, the transmittance of the characters, the color of the background and the transmittance of the background in the first image VR1 are respectively used as the color of the characters, the size of the characters, the transmittance of the characters, the color of the background and the transmittance of the background in the second image VR2. In other words, in the second image VR2, the same color as the color of the characters in the first image VR1, namely the standard character color, is used as the color of the characters in the second image VR2. Further, in the second image VR2, the same size as the size of the characters in the first image VR1, namely the size of the standard character, is used as the size of the characters in the second image VR2. Further, in the second image VR2, the same transmittance as the transmittance of the characters in the first image VR1, namely the standard character transmittance, is used as the transmittance of the characters in the second image VR2. Further, in the second image VR2, the same color as the color of the background in the first image VR1, namely the standard background color, is used as the color of the background in the second image VR2. Further, in the second image VR2, the same transmittance as the transmittance of the background in the first image VR1, namely the standard background transmittance, is used as the transmittance of the background in the second image VR2.

As described above, in the examples shown in FIG. 5 and FIG. 6, the number of pieces of the second information (i.e., the number of the types of the information included in the second information) to be displayed on the display device 40 in the case in which the distance between the operator H and the robot 20 is the second distance shorter than the first distance is smaller than the number of pieces of the second information (i.e., the number of the types of the information included in the second information) to be displayed on the display device 40 in the case in which the distance between the operator H and the robot 20 is the first distance. Thus, in the robotic system 1, it is possible to reduce the proportion of the operating information image to the eyesight of the operator H in the case in which the distance between the operator H and the robot 20 is the second distance. As a result, it is possible for the robotic system 1 to achieve that the closer to the robot 20 the operator H becomes, the easier it becomes to make the operator H visually recognize the whole image of the robot 20, and it is possible to prevent the operator H from having contact with the robot 20.

It should be noted that it is also possible to adopt a configuration in which the second image VR2 does not include the first information. Further, it is also possible to adopt a configuration in which the second image VR2 does not include the second information. Further, it is also possible to adopt a configuration in which the second image VR2 includes other information instead of either one or both of the first information and the second information. Further, it is also possible to adopt a configuration in which the second image VR2 includes other information in addition to both of the first information and the second information. Further, it is also possible for the second image VR2 to be an image including a character string smaller in the number of characters than that included in the first image VR1. In this case, the second image VR2 includes the character string constituted by 12 characters of “CONTINUATION” instead of, for example, the character string constituted by 21 characters of “IN CONTINUOUS OPERATION” included in the first image VR1. Further, it is possible for the second image VR2 to have a different shape from the shape of the first image VR1.

### Modified Example 1 of Embodiment

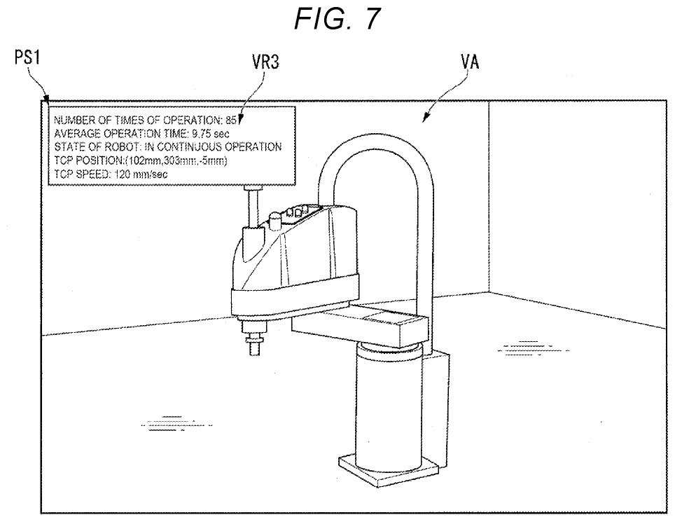

It is also possible for the display control section 361 to have a configuration of making the display device 40 display, for example, a third image VR3 shown in FIG. 7 as the operating information image with the second display configuration in the case in which the distance between the operator H and the robot 20 is the second distance. FIG. 7 is a diagram showing a second example of the scenery viewed by the operator H through the display section provided to the display device 40 in the case in which the operating information image with the second display configuration is displayed on the display device 40. Here, the third image VR3 shown in FIG. 7 represents an example of the operating information image with the second display configuration.

As described above, the display control device 361 changes the display configuration other than the display position of the operating information image of the robot 20 displayed on the display device 40 based on the distance between the operator H and the robot 20. Therefore, in the example shown in FIG. 7, the third image VR3 is displayed at the display position PS1 described above in the display area of the display device 40. Here, the display position of the third image VR3 in the display area is represented by a position of the uppermost left end of the third image VR3 in this example similarly to the case of the first image VR1. In other words, in the case in which the third image VR3 is displayed in the display area, the position of the uppermost left end of the third image VR3 coincides with the display position PS1. Thus, it is possible for the display control section 361 to prevent the visibility of the operating information image for the operator H from deteriorating due to the change in the position of the operating information image.

As shown in FIG. 7, the third image VR3 is an image smaller in character size than the first image VR1. In other words, in the third image VR3, a smaller size than the size of the characters in the first image VR1, namely a smaller size than the size of the standard character, is used as the size of the characters in the third image VR3. In other words, in the examples shown in FIG. 5 and FIG. 7, the size of the characters of the operating information image to be displayed on the display device 40 in the case in which the distance between the operator H and the robot 20 is the second distance is smaller than the size of the characters of the operating information image to be displayed on the display device 40 in the case in which the distance between the operator H and the robot 20 is the first distance.

As described above, in this example, the size of the background in the operating information image is determined in accordance with the size of the characters in the operating information image. Therefore, the size of the third image VR3 is smaller than the size of the first image VR1. Therefore, in the robotic system 1, by varying the size of the characters in the operating information image in accordance with the distance between the operator H and the robot 20, it is possible to reduce the proportion of the operating information image to the eyesight of the operator H in the case in which the distance between the operator H and the robot 20 is the second distance. As a result, it is possible for the robotic system 1 to achieve that the closer to the robot 20 the operator H becomes, the easier it becomes to make the operator H visually recognize the whole image of the robot 20, and it is possible to prevent the operator H from having contact with the robot 20. Here, each of the size of the first image VR1 and the size of the third image VR3 is an example of the display area of the operating information.

It should be noted that it is also possible to adopt a configuration in which the third image VR3 does not include the first information. Further, it is also possible to adopt a configuration in which the third image VR3 does not include the second information. Further, it is also possible to adopt a configuration in which the third image VR3 includes other information instead of either one or both of the first information and the second information. Further, it is also possible to adopt a configuration in which the third image VR3 includes other information in addition to both of the first information and the second information. Further, in the third image VR3, it is also possible to adopt a configuration in which the size of some of the characters in the character string included in the third image VR3 is smaller than the size of the standard character.

### Modified Example 2 of Embodiment

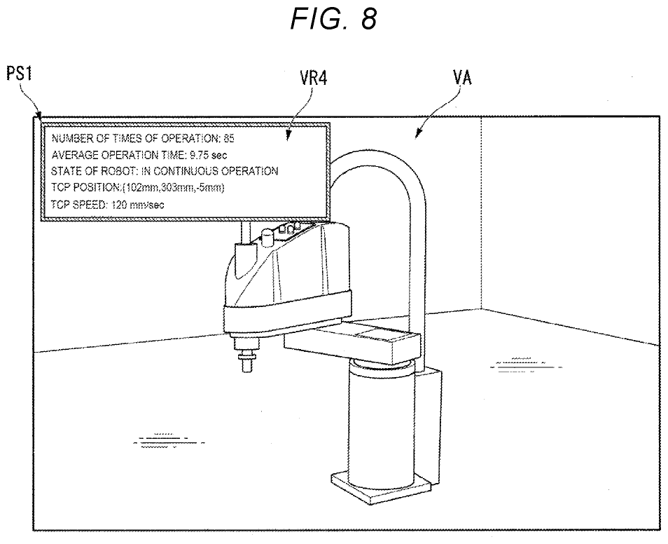

It is also possible for the display control section 361 to have a configuration of making the display device 40 display, for example, a fourth image VR4 shown in FIG. 8 as the operating information image with the second display configuration in the case in which the distance between the operator H and the robot 20 is the second distance. FIG. 8 is a diagram showing a third example of the scenery viewed by the operator H through the display section provided to the display device 40 in the case in which the operating information image with the second display configuration is displayed on the display device 40. Here, the fourth image VR4 shown in FIG. 8 represents an example of the operating information image with the second display configuration.

As described above, the display control device 361 changes the display configuration other than the display position of the operating information image of the robot 20 displayed on the display device 40 based on the distance between the operator H and the robot 20. Therefore, in the example shown in FIG. 8, the fourth image VR4 is displayed at the display position PS1 described above in the display area of the display device 40. Here, the display position of the fourth image VR4 in the display area is represented by a position of the uppermost left end of the fourth image VR4 in this example similarly to the case of the first image VR1. In other words, in the case in which the fourth image VR4 is displayed in the display area, the position of the uppermost left end of the fourth image VR4 coincides with the display position PS1. Thus, it is possible for the display control section 361 to prevent the visibility of the operating information image for the operator H from deteriorating due to the change in the position of the operating information image.

As shown in FIG. 8, the fourth image VR4 is an image different in color of the character from the first image VR1. In other words, in the fourth image VR4, a different color from the color of the characters in the first image VR1, namely the standard character color, is used as the color of the characters in the fourth image VR4. In other words, in the examples shown in FIG. 5 and FIG. 8, the color (the color of the characters in this example) of the operating information image to be displayed on the display device 40 in the case in which the distance between the operator H and the robot 20 is the first distance and the color (the color of the characters in this example) of the operating information image to be displayed on the display device 40 in the case in which the distance between the operator H and the robot 20 is the second distance are different from each other.

For example, since the first distance is a long distance compared to the second distance, in the case in which the distance between the operator H and the robot 20 is the first distance, there is a low possibility that the operator H and the robot 20 have contact with each other. Therefore, the color of the characters in the first image VR1 is, for example, a blue color which is often used for representing the fact that safely is achieved. In contrast, in the case in which the distance between the operator H and the robot 20 is the second distance, there is a high possibility that the operator H has contact with the robot 20. Therefore, the color of the characters in the fourth image VR4 is, for example, a red color which is often used for representing warning. It should be noted that the color of the characters in the first image VR1 can also be another color different from the color of the characters in the fourth image VR4 instead of the blue color. Further, the color of the characters in the fourth image VR4 can also be another color different from the color of the characters in the first image VR1 instead of the red color.

Thus, it is possible for the robotic system 1 to announce that the possibility that the operator H has contact with the robot 20 has been raised in the case in which the distance between the operator H and the robot 20 is the second distance. As a result, it is possible for the robotic system 1 to prevent the operator H from having contact with the robot 20.

It should be noted that it is also possible to adopt a configuration in which the fourth image VR4 does not include the first information. Further, it is also possible to adopt a configuration in which the fourth image VR4 does not include the second information. Further, it is also possible to adopt a configuration in which the fourth image VR4 includes other information instead of either one or both of the first information and the second information. Further, it is also possible to adopt a configuration in which the fourth image VR4 includes other information in addition to both of the first information and the second information. Further, in the fourth image VR4, it is also possible to adopt a configuration in which the color of some of the characters included in the fourth image VR4 is a different color from the standard character color. Further, in the fourth image VR4, it is also possible to adopt a configuration in which the color of a part or the whole of the background in the fourth image VR4 is a different color from the standard background color. Here, the color of the characters included in each of the first image VR1 and the fourth image VR4 is an example of the color of the operating information. Further, the color of the background of each of the first image VR1 and the fourth image VR4 is an example of the color of the operating information.

### Modified Example 3 of Embodiment

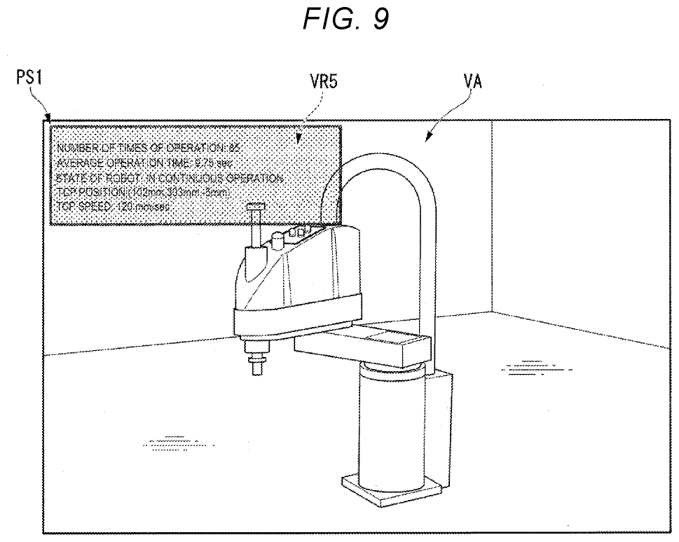

It is also possible for the display control section 361 to have a configuration of making the display device 40 display, for example, a fifth image VR5 shown in FIG. 9 as the operating information image with the second display configuration in the case in which the distance between the operator H and the robot 20 is the second distance. FIG. 9 is a diagram showing a fourth example of the scenery viewed by the operator H through the display section provided to the display device 40 in the case in which the operating information image with the second display configuration is displayed on the display device 40. Here, the fifth image VR5 shown in FIG. 9 represents an example of the operating information image with the second display configuration.

As described above, the display control device 361 changes the display configuration other than the display position of the operating information image of the robot 20 displayed on the display device 40 based on the distance between the operator H and the robot 20. Therefore, in the example shown in FIG. 9, the fifth image VR5 is displayed at the display position PS1 described above in the display area of the display device 40. Here, the display position of the fifth image VR5 in the display area is represented by a position of the uppermost left end of the fifth image VR5 in this example similarly to the case of the first image VR1. In other words, in the case in which the fifth image VR5 is displayed in the display area, the position of the uppermost left end of the fifth image VR5 coincides with the display position PS1. Thus, it is possible for the display control section 361 to prevent the visibility of the operating information image for the operator H from deteriorating due to the change in the position of the operating information image.

As shown in FIG. 9, the fifth image VR5 is an image high in transmittance of the characters than the first image VR1, and high in transmittance of the background than the first image VR1. In other words, in the fifth image VR5, the transmittance of the characters in the first image VR1, namely a higher transmittance than the standard character transmittance, is used as the transmittance of the characters in the fifth image VR5. Further, in the fifth image VR5, the transmittance of the background in the first image VR1, namely a higher transmittance than the standard background transmittance, is used as the transmittance of the background in the fifth image VR5. In other words, in the examples shown in FIG. 5 and FIG. 9, the transmittances (the transmittance of the characters and the transmittance of the background in this example) of the operating information image to be displayed on the display device 40 in the case in which the distance between the operator H and the robot 20 is the second distance are higher than the transmittances (the transmittance of the characters and the transmittance of the background in this example) of the operating information image to be displayed on the display device 40 in the case in which the distance between the operator H and the robot 20 is the first distance.

Thus, in the robotic system 1, by varying the transmittances of the operating information image in accordance with the distance between the operator H and the robot 20, it is possible to prevent the eyesight of the operator H from being shaded by the operating information image in the case in which the distance between the operator H and the robot 20 is the second distance. As a result, it is possible for the robotic system 1 to achieve that the closer to the robot 20 the operator H becomes, the easier it becomes to make the operator H visually recognize the whole image of the robot 20, and it is possible to prevent the operator H from having contact with the robot 20.

It should be noted that it is also possible to adopt a configuration in which the fifth image VR5 does not include the first information. Further, it is also possible to adopt a configuration in which the fifth image VR5 does not include the second information. Further, it is also possible to adopt a configuration in which the fifth image VR5 includes other information instead of either one or both of the first information and the second information. Further, it is also possible to adopt a configuration in which the fifth image VR5 includes other information in addition to both of the first information and the second information. Further, in the fifth image VR5, it is also possible to adopt a configuration in which the transmittance of some of the characters included in the fifth image VR5 is a higher transmittance than the standard character transmittance. Further, in the fifth image VR5, it is also possible to adopt a configuration in which the transmittance of a part of the background of the fifth image VR5 is a higher transmittance than the standard background transmittance. Further, in the fifth image VR5, it is also possible to adopt a configuration in which the transmittance of either one of the characters included in the fifth image VR5 and the background of the fifth image VR5 is a higher transmittance than the standard character transmittance. Here, the transmittance of the characters included in each of the first image VR1 and the fifth image VR5 is an example of the transmittance of the operating information. Further, the transmittance of the background of each of the first image VR1 and the fifth image VR5 is an example of the transmittance of the operating information.

### Modified Example 4 of Embodiment

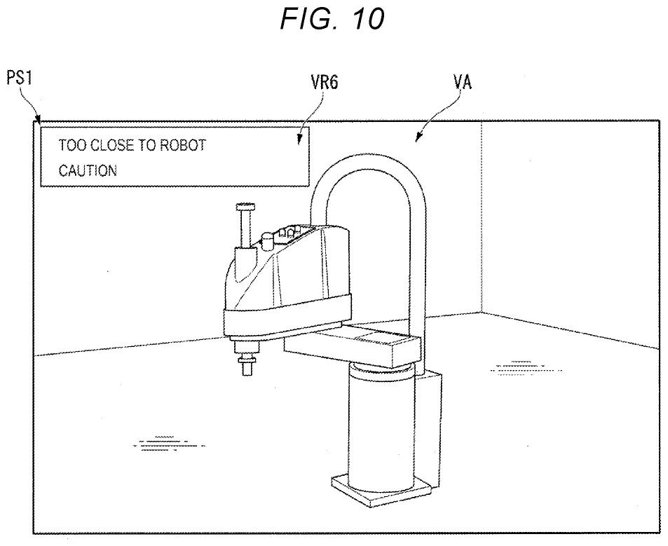

It is also possible for the display control section 361 to have a configuration of making the display device 40 display, for example, a sixth image VR6 shown in FIG. 10 as the operating information image with the second display configuration in the case in which the distance between the operator H and the robot 20 is the second distance. FIG. 10 is a diagram showing a fifth example of the scenery viewed by the operator H through the display section provided to the display device 40 in the case in which the operating information image with the second display configuration is displayed on the display device 40. Here, the sixth image VR6 shown in FIG. 10 represents an example of the operating information image with the second display configuration.

As described above, the display control device 361 changes the display configuration other than the display position of the operating information image of the robot 20 displayed on the display device 40 based on the distance between the operator H and the robot 20. Therefore, in the example shown in FIG. 10, the sixth image VR6 is displayed at the display position PS1 described above in the display area of the display device 40. Here, the display position of the sixth image VR6 in the display area is represented by a position of the uppermost left end of the sixth image VR6 in this example similarly to the case of the first image VR1. In other words, in the case in which the sixth image VR6 is displayed in the display area, the position of the uppermost left end of the sixth image VR6 coincides with the display position PS1. Thus, it is possible for the display control section 361 to prevent the visibility of the operating information image for the operator H from deteriorating due to the change in the position of the operating information image.

As shown in FIG. 10, the sixth image VR6 is an image including attention-seeking information as information calling for attention instead of both of the first information and the second information. In the example shown in FIG. 10, the sixth image VR6 includes a combination of a character string of “TOO CLOSE TO ROBOT” and a character string of “CAUTION” as an example of the attention-seeking information. In other words, in the examples shown in FIG. 5 and FIG. 10, the operating information image is displayed on the display device 40 in the case in which the distance between the operator H and the robot 20 is the first distance, and the attention-seeking information is displayed on the display device 40 in the case in which the distance between the operator H and the robot 20 is the second distance.

Thus, it is possible for the robotic system 1 to announce that the possibility that the operator H has contact with the robot 20 has been raised in the case in which the distance between the operator H and the robot 20 is the second distance. As a result, it is possible for the robotic system 1 to prevent the operator H from having contact with the robot 20.

It should be noted that it is also possible to adopt a configuration in which the sixth image VR6 includes the first information in addition to the attention-seeking information, or to adopt a configuration in which the sixth image VR6 includes the second information, or to adopt a configuration in which the sixth image VR6 includes other information. Further, the attention-seeking information can also be other information such as a diagram instead of the character string.

### Modified Example 5 of Embodiment

It is also possible for the display control section 361 to have a configuration of obtaining the information representing the speed of the TCP from the robot control section 363, and then varying either one or both of the color of the characters included in the operating information image and the color of the background of the operating information image in accordance with the speed represented by the information thus obtained. Each of the color of the characters included in the operating information image and the color of the background of the operating information image is an example of the color of the operating information. Hereinafter, as an example, there will be described the case in which the display control section 361 varies the color of the characters included in the operating information image in accordance with the speed.

In the case in which, for example, the speed of the TCP is lower than a second threshold value determined in advance, the display control section 361 determines that the speed is a first speed. In contrast, in the case in which the speed is equal to or higher than the second threshold value, the display control section 361 determines that the speed is a second speed higher than the first speed. Further, in the case in which the display control section 361 has determined that the speed of the TCP is the first speed, the display control section 361 selects the standard character color (e.g., the blue color described above) as the color of the characters included in the operating information image. In contrast, in the case in which the display control section 361 has determined that the speed of the TCP is the second speed, the display control section 361 selects a different color (e.g., the red color described above) different from the standard character color as the color of the characters included in the operating information image.

The display control section 361 performs such selection of the color of the characters included in the operating information image in the step S140 shown in FIG. 4 together with the process of the step S140 described in the embodiment. Specifically, the display control section 361 replaces the color of the characters in the display configuration selected in accordance with the distance between the operator H and the robot 20 with the color of the characters selected in accordance with the speed of the TCP. Thus, it is possible for the robotic system 1 to prevent the operator H from coming closer to the robot 20 in the case in which the speed of the TCP is high.

It should be noted that it is also possible for the display control section 361 to have a configuration of making the display device 40 display the image including the attention-seeking information described above in addition to the operating information image in the case in which the display control section 361 has determined that the speed of the TCP is the second speed.

### Modified Example 6 of Embodiment

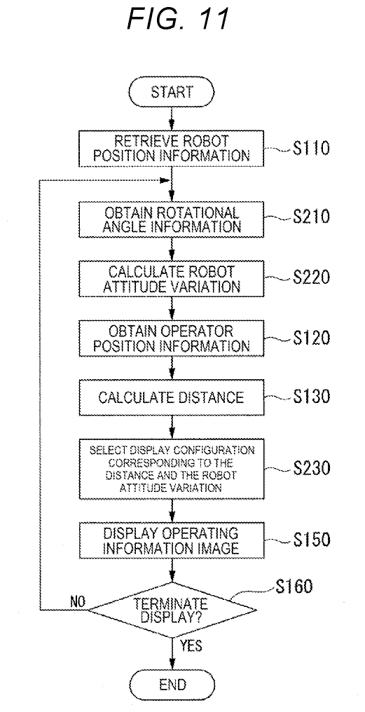

It is also possible for the display control section 361 to have a configuration of displaying the operating information image on the display device 40 due to the process of the flowchart shown in FIG. 11 instead of the process of the flowchart shown in FIG. 4. FIG. 11 is a diagram showing another example of the flow of the process of the robot control device 30 for making the display device 40 display the operating information image. It should be noted that the respective processes of the step S110, the step S120, the step S130, the step S150 and the step S160 shown in FIG. 11 are substantially the same processes as the respective processes of the step S110, the step S120, the step S130, the step S150 and the step S160 shown in FIG. 4, and therefore, the description thereof will be omitted.

After the process of the step S110 shown in FIG. 11 has been performed, the display control section 361 obtains (step S210) the information representing the respective pivotal angles of the four motors from the respective encoders of the four motors provided to the robot 20. In FIG. 11, the information is referred to as pivotal angle information.

Then, the display control section 361 calculates (step S220) a robot attitude variation as a variation of the attitude of the robot 20 based on the pivotal angles respectively represented by the four pieces of information obtained in the step S210. Specifically, the display control section 361 generates, for example, a vector having the pivotal angles respectively represented by the four pieces of information obtained in the step S210 as the components, and then calculates the norm of the vector thus generated as the robot attitude variation. It should be noted that it is also possible to adopt a configuration in which the display control section 361 calculates another amount based on the pivotal angles as the robot attitude variation.

It should be noted that it is also possible for the display control section 361 to have a configuration of performing the process in the step S210 through the step S220 shown in FIG. 11, and the process in the step S120 through the step S130 shown in FIG. 11 in a reverse order, or a configuration of performing them in parallel to each other.

After the process in the step S130 shown in FIG. 11 is performed, the display control section 361 selects (step S230) the display configuration corresponding to the robot attitude variation calculated in the step S220 and the distance calculated in the step S130 shown in FIG. 11. For example, in the case in which the distance is the first distance, and at the same time, the robot attitude variation is smaller than a third threshold value determined in advance, the display control section 361 selects the first display configuration described above as the display configuration of the operating information image. In contrast, in the case in which either one of the condition that the distance is the second distance and the condition that the robot attitude variation is not smaller than the threshold value is true, the display control section 361 selects the second display configuration described above as the display configuration of the operating information image.

As described above, it is possible for the robotic system 1 to have a configuration of displaying the operating information image on the display device 40 due to the process of the flowchart shown in FIG. 11. Thus, it is possible for the robotic system 1 to notify the operator H of some information for preventing the operator H from having contact with the robot 20 even in either one of the case in which the operator H comes too close to the robot 20 and the case in which the variation of the attitude of the robot 20 is large. As a result, it is possible for the robotic system 1 to prevent the operator H from having contact with the robot 20.

It should be noted that it is also possible for the display control section 361 to have a configuration of calculating the distance between the position of the TCP and the operator H instead of the robot attitude variation to change the display configuration of the operating information image in accordance with the distance thus calculated.

Here, it is also possible for the display control section 361 explained in the above description to have a configuration of receiving an operation from the user to change the display position of the operating information image in the display area of the display device 40 in accordance with the operation thus received. Thus, it is possible for the robotic system 1 to display the operating information image at the position desired by the user in the display area.

Further, it is also possible for the display control section 361 explained in the above description to have a configuration of maximizing the transmittance of the operating information image to disable (i.e., delete the operating information image from the display area of the display device 40) the operator H to visually recognize the operating information image in the case in which the display control section 361 has determined that the distance calculated in the step S130 shown in FIG. 4 is the second distance.

Further, it is also possible for the display control section 361 explained in the above description to have a configuration of displaying the image including the attention-seeking information described above on the entire area of the display area of the display device 40 in the case in which the display control section 361 has determined that the distance calculated in the step S130 shown in FIG. 4 is the second distance.

Further, the display control section 361 explained in the above description displays an image in a virtual space where a virtual robot 20 is disposed on the display section of the display device 40 together with the operating information image described above in the case in which the display device 40 is a display device which cannot be worn by the operator H such as a teaching pendant. On this occasion, it is possible for the display control section 361 to receive an operation from a user to change the position of a point of sight when viewing the inside of the virtual space in accordance with the operation thus received. Further, in that case, it is also possible for the display control section 361 to have a configuration in which a layer on which the image in the virtual space is disposed is disposed on the front side of a layer on which the operating information image is disposed in the case in which the display control section 361 has determined that the distance between the operator H and the robot 20 is the second distance. In other words, in this case, the display control section 361 masks a part or the whole of the operating information image with the image in the virtual space.

Further, it is also possible to adopt a configuration in which the display control section 361 explained in the above description is provided to the display device 40, an information processing device for intervening between the robot control device 30 and the display device 40, or other information processing devices instead of the configuration in which the display control section 361 is provided to the robot control device 30. In the case in which the display control section 361 is provided to the display device 40, it is also possible for the robot control device 30 to have a configuration of, for example, outputting a variety of types of information necessary to generate the operating information image to the display control section 361 of the display device 40, or a configuration of outputting the information such as the operator position information, the robot position information, or the information representing the respective pivotal angles of the first motor through the fourth motor to the display control section 361 of the display device 40.

Further, it is also possible for the robot 20 explained in the above description to be another robot such as a Cartesian coordinate robot or a vertical articulated robot (e.g., a single-arm robot or a multi-arm robot) instead of the horizontal articulated robot. The Cartesian coordinate robot is, for example, a gantry robot.

Further, it is also possible for the position detection device 25 explained in the above description can also be another sensor capable of detecting the position of the operator H in the periphery of the robot 20 such as a laser range sensor instead of the area sensor.

Further, it is also possible for the position detection device 25 explained in the above description to have a configuration of detecting a relative position of the operator H to the robot 20 instead of the configuration of detecting the position of the operator H in the periphery of the robot 20.

Further, it is also possible for the position detection device 25 explained in the above description to be configured integrally with the robot control device 30, or to be configured integrally with the robot 20.

Further, it is also possible for the position detection device 25 explained in the above description to be a device capable of detecting the position of the own device such as a GPS (global positioning system) receiver. In this case, the position detection device 25 is disposed inside or outside the display device 40, for example, and detects the position of the position detection device 25 (or the position of the display device 40) as the position of the operator H to output the operator position information representing the position thus detected to the robot control device 30. Further, in this case, the position detection device 25 has a configuration which can be worn or held by the operator H, for example, and is worn or held by the operator H to detect the position of the position detection device 25 as the position of the operator H, and output the operator position information representing the position thus detected to the robot control device 30. Further, in the case in which the position detection device 25 is disposed inside or outside of the display device 40, the robot control device 30 obtains the operator position information from the position detection device 25 provided to the display device 40 to calculate the distance between the position detection device 25 (or the display device 40) and the robot 20 as the distance between the operator H and the robot 20 based on the operator position information thus obtained.

Further, it is also possible to adopt a configuration in which the first information explained in the above description includes other information than the second information in addition to the information representing the current state of the robot 20.

Further, it is also possible to adopt a configuration in which the second information explained in the above description includes other information than the first information instead of a part or the whole of the information representing an operation of the robot 20, the information related to the production capacity of the production line in which the robot 20 is operating, and so on.

Further, it is also possible to adopt a configuration in which the second information explained in the above description includes other information than the first information in addition to a part or the whole of the information representing an operation of the robot 20, the information related to the production capacity of the production line in which the robot 20 is operating, and so on.

Further, it is also possible to adopt a configuration in which the position of the robot 20 explained in the above description is represented by the position of the TCP, or a configuration in which the position of the robot 20 is represented by the position of the tip of the robot 20, or a configuration in which the position of the robot 20 is represented by another position corresponding to the robot 20 instead of the configuration in which the position of the robot 20 is represented by the position determined in advance in the base B. Further, in the case in which the position of the robot 20 can move (e.g., the case in which the position of the robot 20 is represented by the position of the TCP), it is also possible to adopt a configuration in which the position of the robot 20 is represented by a position to be a target with which the position of the robot 20 is made to coincide next instead of the current position of the robot 20.

As described hereinabove, the control device (the robot control device 30 in this example) in the embodiment is a control device for controlling the robot (the robot 20 in this example), and is provided with the display control section (the display control section 361 in this example) for changing the display configuration other than the display position of the operating information of the robot to be displayed on the display device (the display section provided to the display device 40 in this example) transmitting the visible light based on the distance between the operator (the operator H in this example) and the robot. Further, in the control device, the display configuration in the case in which the distance between the operator and the robot is the first distance and the display configuration in the case in which the distance between the operator and the robot is the second distance shorter than the first distance are different from each other, and the display area of the operating information displayed on the display section in the case in which the distance between the operator and the robot is the second distance is smaller than the display area of the operating information displayed on the display section in the case in which the distance between the operator and the robot is the first distance. Thus, it is possible for the control device to prevent the visibility of the operating information by the operator from degrading due to the change in the display position of the operating information, and at the same time to prevent the operator from having contact with the robot.

Further, in the control device, there can also be used a configuration in which the number of characters of the operating information to be displayed on the display section in the case in which the distance between the operator and the robot is the second distance is smaller than the number of characters of the operating information to be displayed on the display section in the case in which the distance between the operator and the robot is the first distance.

Further, in the control device, there can also be used a configuration in which the size of the characters of the operating information to be displayed on the display section in the case in which the distance between the operator and the robot is the second distance is smaller than the size of the characters of the operating information to be displayed on the display section in the case in which the distance between the operator and the robot is the first distance.

Further, in the control device, there can also be used a configuration in which the operating information is displayed on the display section in the case in which the distance between the operator and the robot is the first distance, and the attention-seeking information is displayed on the display section in the case in which the distance between the operator and the robot is the second distance.

Further, in the control device, there can also be used a configuration in which the operating information includes the first information representing the current state of the robot and the second information different from the first information.

Further, in the control device, there can also be used a configuration in which the number of pieces of the second information to be displayed on the display section in the case in which the distance between the operator and the robot is the second distance shorter than the first distance is smaller than the number of pieces of the second information to be displayed on the display section in the case in which the distance between the operator and the robot is the first distance.

Further, in the control device, there can also be used a configuration in which the color of the operating information to be displayed on the display section in the case in which the speed of the robot is the first speed and the color of the operating information to be displayed on the display section in the case in which the speed of the robot is the second speed higher than the first speed are different from each other.

Further, in the control device, there can also be used a configuration in which the operating information is displayed on the display section in the case in which the speed of the robot is the first speed, and the attention-seeking information is displayed on the display section in the case in which the speed of the robot is the second speed higher than the first speed.

Further, in the control device, there can also be used a configuration in which the distance between the operator and the robot is the distance between the display section and the robot.

Further, the head-mounted display (the display device 40 in this example) is provided with the display section on which the operating information of the robot is displayed, and which transmits the visible light, and the display control section for changing the display configuration other than the display position of the operating information to be displayed on the display section based on the distance between the operator and the robot. Further, in the head-mounted display, the display configuration in the case in which the distance between the operator and the robot is the first distance and the display configuration in the case in which the distance between the operator and the robot is the second distance shorter than the first distance are different from each other, and the display area of the operating information displayed on the display section in the case in which the distance between the operator and the robot is the second distance is smaller than the display area of the operating information displayed on the display section in the case in which the distance between the operator and the robot is the first distance. Thus, it is possible for the head-mounted display to prevent the visibility of the operating information by the operator from degrading due to the change in the display position of the operating information, and at the same time to prevent the operator from having contact with the robot.

Further, in the head-mounted display, there can also be used a configuration in which the number of characters of the operating information to be displayed on the display section in the case in which the distance between the operator and the robot is the second distance is smaller than the number of characters of the operating information to be displayed on the display section in the case in which the distance between the operator and the robot is the first distance.

Further, in the head-mounted display, there can also be used a configuration in which the size of the characters of the operating information to be displayed on the display section in the case in which the distance between the operator and the robot is the second distance is smaller than the size of the characters of the operating information to be displayed on the display section in the case in which the distance between the operator and the robot is the first distance.

Further, in the head-mounted display, there can also be used a configuration in which the operating information is displayed on the display section in the case in which the distance between the operator and the robot is the first distance, and the attention-seeking information is displayed on the display section in the case in which the distance between the operator and the robot is the second distance.

Further, in the head-mounted display, there can also be used a configuration in which the operating information includes the first information representing the current state of the robot and the second information different from the first information.

Further, in the head-mounted display, there can also be used a configuration in which the number of pieces of the second information to be displayed on the display section in the case in which the distance between the operator and the robot is the second distance shorter than the first distance is smaller than the number of pieces of the second information to be displayed on the display section in the case in which the distance between the operator and the robot is the first distance.

Further, in the head-mounted display, there can also be used a configuration in which the color of the operating information to be displayed on the display section in the case in which the speed of the robot is the first speed and the color of the operating information to be displayed on the display section in the case in which the speed of the robot is the second speed higher than the first speed are different from each other.

Further, in the head-mounted display, there can also be used a configuration in which the operating information is displayed on the display section in the case in which the speed of the robot is the first speed, and the attention-seeking information is displayed on the display section in the case in which the speed of the robot is the second speed higher than the first speed.

Further, in the head-mounted display, there can also be used a configuration in which the distance between the operator and the robot is the distance between the display section and the robot.

Although the embodiment of the present disclosure is hereinabove described in detail with reference to the accompanying drawings, the specific configuration is not limited to the embodiment described above, but modifications, replacement, elimination, and so on are allowed within the scope or the spirit of the present disclosure.

Further, it is also possible to arrange that a program for realizing the function of an arbitrary constituent in the device (e.g., the position detection device 25, the robot control device 30 or the display device 40) described hereinabove is recorded on a computer readable recording medium, and then the program is read and then performed by a computer system. It should be noted that the “computer system” mentioned here should include an operating system (OS) and hardware such as peripheral devices. Further, the “computer-readable recording medium” denotes a portable recording medium such as a flexible disk, a magneto-optical disk, a ROM, and a CD (compact disk) -ROM, and a storage device such as a hard disk incorporated in the computer system. Further, the “computer-readable recording medium” should include those holding a program for a certain period of time such as a volatile memory (a RAM) in a computer system to be a server or a client in the case of transmitting the program via a network such as the Internet, or a communication line such as a telephone line.

Further, the program described above can be transmitted from the computer system having the program stored in the storage device or the like to another computer system via a transmission medium or using a transmission wave in the transmission medium. Here, the “transmission medium” for transmitting the program denotes a medium having a function of transmitting information such as a network (a communication network) such as the Internet or a communication line (a communication wire) such as a telephone line.

Further, the program described above can be for realizing a part of the function described above. Further, the program described above can be a program, which can realize the function described above when being combined with a program recorded on the computer system in advance, namely a so-called differential file (a differential program).

What is claimed is:

1. A control device configured to control a robot, the control device comprising:
a display control section configured to change a display configuration other than a display position of operating information of the robot to be displayed on a display section configured to transmit visible light based on a distance between an operator and the robot, wherein
the display configuration in a case in which the distance between the operator and the robot is a first distance and the display configuration in a case in which the distance between the operator and the robot is a second distance shorter than the first distance are different from each other, and
a display area of the operating information to be displayed on the display section in the case in which the distance between the operator and the robot is the second distance is smaller than a display area of the operating information to be displayed on the display section in the case in which the distance between the operator and the robot is the first distance.

2. The control device according to claim 1, wherein
a number of characters of the operating information to be displayed on the display section in the case in which the distance between the operator and the robot is the second distance is smaller than a number of characters of the operating information to be displayed on the display section in the case in which the distance between the operator and the robot is the first distance.

3. The control device according to claim 1, wherein a size of characters of the operating information to be displayed on the display section in the case in which the distance between the operator and the robot is the second distance is smaller than a size of characters of the operating information to be displayed on the display section in the case in which the distance between the operator and the robot is the first distance.

4. The control device according to claim 1, wherein
the operating information is displayed on the display section in the case in which the distance between the operator and the robot is the first distance, and attention-seeking information is displayed on the display section in the case in which the distance between the operator and the robot is the second distance.

5. The control device according to claim 1, wherein
the operating information includes first information representing a current state of the robot and second information different from the first information.

6. The control device according to claim 5, wherein
a number of pieces of the second information to be displayed on the display section in the case in which the distance between the operator and the robot is the second distance shorter than the first distance is smaller than a number of pieces of the second information to be displayed on the display section in the case in which the distance between the operator and the robot is the first distance.

7. The control device according to claim 1, wherein
a color of the operating information to be displayed on the display section in a case in which a speed of the robot is a first speed and a color of the operating information to be displayed on the display section in a case in which the speed of the robot is a second speed higher than the first speed are different from each other.

8. The control device according to claim 1, wherein
the operating information is displayed on the display section in a case in which a speed of the robot is a first speed, and attention-seeking information is displayed on the display section in a case in which the speed of the robot is a second speed higher than the first speed.

9. The control device according to claim 1, wherein
the distance between the operator and the robot is a distance between the display section and the robot.

10. A head-mounted display comprising:
a display section on which operating information of a robot is displayed, and which transmits visible light; and
a display control section configured to change a display configuration other than a display position of the operating information to be displayed on the display section based on a distance between an operator and the robot, wherein
the display configuration in a case in which the distance between the operator and the robot is a first distance and the display configuration in a case in which the distance between the operator and the robot is a second distance shorter than the first distance are different from each other, and
a display area of the operating information to be displayed on the display section in the case in which the distance between the operator and the robot is the second distance is smaller than a display area of the operating information to be displayed on the display section in the case in which the distance between the operator and the robot is the first distance.

11. The head-mounted display according to claim 10, wherein
a number of characters of the operating information to be displayed on the display section in the case in which the distance between the operator and the robot is the second distance is smaller than a number of characters of the operating information to be displayed on the display section in the case in which the distance between the operator and the robot is the first distance.

12. The head-mounted display according to claim 10, wherein
a size of characters of the operating information to be displayed on the display section in the case in which the distance between the operator and the robot is the second distance is smaller than a size of characters of the operating information to be displayed on the display section in the case in which the distance between the operator and the robot is the first distance.

13. The head-mounted display according to claim 10, wherein
the operating information is displayed on the display section in the case in which the distance between the operator and the robot is the first distance, and attention-seeking information is displayed on the display section in the case in which the distance between the operator and the robot is the second distance.

14. The head-mounted display according to claim 10, wherein
the operating information includes first information representing a current state of the robot and second information different from the first information.

15. The head-mounted display according to claim 14, wherein
a number of pieces of the second information to be displayed on the display section in the case in which the distance between the operator and the robot is the second distance shorter than the first distance is smaller than a number of pieces of the second information to be displayed on the display section in the case in which the distance between the operator and the robot is the first distance.

16. The head-mounted display according to claim 10, wherein
a color of the operating information to be displayed on the display section in a case in which a speed of the robot is a first speed and a color of the operating information to be displayed on the display section in a case in which the speed of the robot is a second speed higher than the first speed are different from each other.

17. The head-mounted display according to claim 10, wherein
the operating information is displayed on the display section in a case in which a speed of the robot is a first speed, and attention-seeking information is displayed on the display section in a case in which the speed of the robot is a second speed higher than the first speed.

18. The head-mounted display according to claim 10, wherein
the distance between the operator and the robot is a distance between the display section and the robot.

19. A robotic system comprising:
a robot;
a head-mounted display having a display section on which operating information of the robot is displayed, and which transmits visible light; and
a display control section configured to change a display configuration other than a display position of the operating information to be displayed on the display section based on a distance between an operator and the robot, wherein
the display configuration in a case in which the distance between the operator and the robot is a first distance and the display configuration in a case in which the distance between the operator and the robot is a second distance shorter than the first distance are different from each other, and
a display area of the operating information to be displayed on the display section in the case in which the distance between the operator and the robot is the second distance is smaller than a display area of the operating information to be displayed on the display section in the case in which the distance between the operator and the robot is the first distance.
